(19) United States
(12) Patent Application Publication
(10) Pub. No.: US 2025/0350103 A1
(43) Pub. Date: Nov. 13, 2025

(54) Transition Fixing

(71) Applicant: HellermannTyton Corporation, Milwaukee, WI (US)

(72) Inventors: Mark W. Cors, St. Francis, WI (US); Cabren Spangler, Menomonee Falls, WI (US)

(21) Appl. No.: 19/078,029

(22) Filed: Mar. 12, 2025

Related U.S. Application Data
(60) Provisional application No. 63/644,755, filed on May 9, 2024.
(60) Provisional application No. 63/705,190, filed on Oct. 9, 2024.

(51) Int. Cl. H02G 3/04

(52) U.S. Cl. CPC H02G 3/045

(57) ABSTRACT

Described are transition fixing apparatuses, which are operable to guide, support, and/or protect an elongated article that is routed from a first support surface to a second support surface and across a transition area that is located between the first and second support surfaces. In an aspect, a transition fixing apparatus includes a first support connector operable to attach to a first support surface, a second support connector operable to attach to a second support surface, and a flexible spine portion that extends between the first support connector and the second support connector. The flexible spine portion includes a retainer portion that is operable to retain an elongated article to enable the flexible spine portion to route the elongated article from the first support surface to the second support surface.

### INCORPORATION BY REFERENCE

This application claims the benefit of U.S. Provisional Application No. 63/644,755, filed May 9, 2024, and U.S. Provisional Application No. 63/705,190, filed Oct. 9, 2024, the disclosures of which are incorporated herein by reference.

### BACKGROUND

Technicians regularly route elongated articles (e.g., cables) from a first location to a second location. The route may include planar paths (e.g., along a side frame of a conveyor system) and transition areas where the elongated article route transitions from a first orientation to a second orientation. Examples of transition areas include non-planar portions (e.g., curves, turns, plane changes), bridge portions where the elongated articles bridge (e.g., across a gap) from a first workpiece to a second workpiece, and/or obstacles (e.g., a subassembly, another component) present along the route.

In some installations, the technician may apply a protective cover (e.g., a sleeve, a wrap, convolute tubing) at the transition area to support and protect the elongated articles. The technician may then use mount fixings (e.g., adhesive cable tie saddle mounts) on first and second support surfaces to mount the elongated articles to respective support surfaces. Movement (e.g., vibration, oscillation) of the elongated articles at the transition area can be a common source of issues. A first example of such an issue is a mount fixing failure that results in the detachment of the mount fixing from the support surface. For example, a free end of the protective cover may move and vibrate against the mount fixing, which causes the adhesive mount to fail. A second example of such an issue is damage to the elongated article. For example, the free end of the protective cover may move and vibrate on the elongated article, causing damage to the elongated article (e.g., abrasion of the insulation on a wire). To address such issues, it is known to use one or more straps (e.g., cable ties) to compress the ends of the protective cover onto the elongated article. However, such a solution may create pinch points that further result in movement-induced damage to the elongated article.

### SUMMARY

This document describes transition fixing apparatuses (e.g., transition fixings). In implementations, a transition fixing includes a first support connector that is operable to attach to a first support surface, a second support connector that is operable to attach to a second support surface, and a flexible spine portion that extends between the first support connector and the second support connector. The flexible spine portion includes a retainer portion (e.g., a wiring hold) that is operable to retain an elongated article and to route the elongated article from the first support surface to the second support surface. In aspects, a transition fixing may include multiple flexible spine portions.

In additional implementations, a transition fixing includes an attachment portion that is operable to attach to a first end of a conduit and a support connector that is operable to attach to a support surface. The support connector extends from the attachment portion. The attachment portion includes a clip portion that is operable to clip onto the first end of the conduit to attach the attachment portion to the first end of the conduit. In aspects, a transition fixing may include multiple attachment portions and/or support connectors.

In further implementations, a transition fixing includes an attachment portion that is operable to attach to a first end of a conduit and a support connector that is operable to attach to a support surface. The support connector extends from the attachment portion, which includes a clamp portion. The clamp portion is operable to clamp onto the first end of the conduit to attach the attachment portion to the first end of the conduit. In aspects, a transition fixing may include multiple attachment portions and/or support connectors.

This Summary is provided to introduce simplified concepts of transition fixing apparatuses, which are further described below in the Detailed Description and are illustrated in the Drawings. This Summary is not intended to identify essential features of the claimed subject matter, nor is it intended for use in determining the scope of the claimed subject matter.

### BRIEF DESCRIPTION OF THE DRAWINGS

This publication describes details of one or more implementations of transition fixing apparatuses with reference to the following Drawings.

FIG. 1 is a schematic representation of aspects of transition fixings positioned between support surfaces.

FIG. 2A is a perspective view of a transition fixing.

FIG. 2B is an environmental, partial, plan view of the transition fixing of FIG. 2A.

FIG. 3 is a cross-sectional view along lines 3-3 in FIG. 2A.

FIG. 4 is a partial, perspective view of a shovel-head support connector of a transition fixing.

FIGS. 5A and 5B are end views of the transition fixing of FIG. 4, illustrating a support connector installation process.

FIG. 6A is a partial, side view of a transition fixing installed on a support structure.

FIG. 6B is a cross-sectional view along lines 6B-6B in FIG. 6A.

FIG. 7A is a perspective view of a transition fixing.

FIG. 7B is an exploded perspective view of the transition fixing of FIG. 7A.

FIG. 8A is a perspective view of a clip support connector of a transition fixing.

FIG. 8B is an environmental side view of the clip support connector and transition fixing of FIG. 8A.

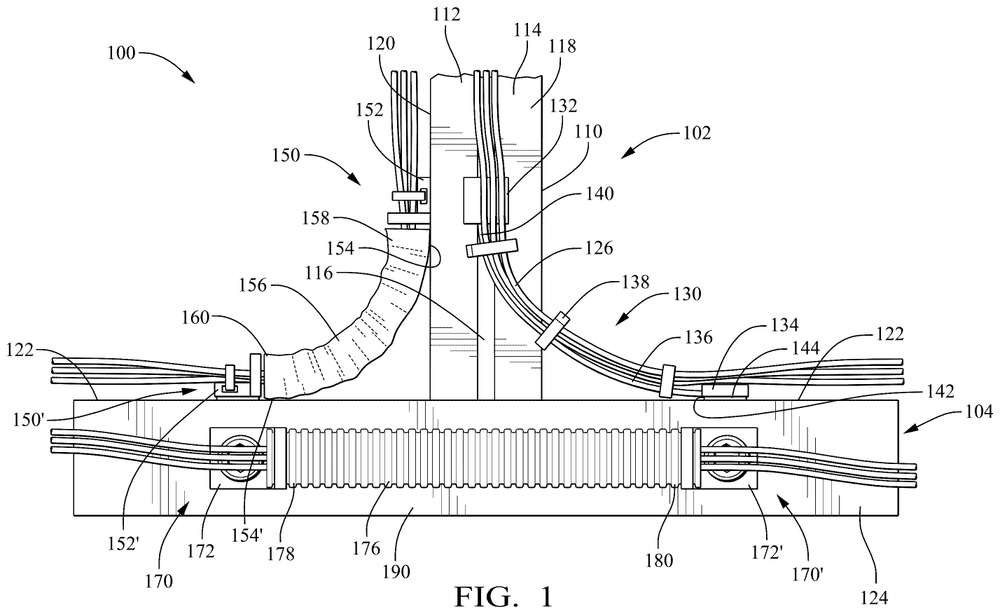

In this description, the first digit(s) of a reference character (e.g., call-out number) may correlate with the first figure number in which the reference character is labeled. For example, reference characters that start with a 1 (e.g., workpiece 102, transition fixing 130) may represent details first called out with respect to FIG. 1. Further, the same reference characters in different Drawings may identify the same or similar features, elements, and/or parts.

### DETAILED DESCRIPTION

The following detailed description of example implementations of transition fixing apparatuses refers to the accompanying Drawings. The implementations of transition fixing apparatuses described herein are operable to guide, support, and/or protect an elongated article that is routed from a first support surface to a second support surface and across a transition area (e.g., a gap between the first and second support surfaces, a sharp edge, an unsupported bridge, a curve, an obstacle) that is located between the first and second support surfaces. In this context, a transition area is a location where the elongated article transitions from a first orientation to a second orientation. Examples of transition areas include, but are not limited to, (a) a transition from a horizontal run to a vertical run, (b) a bridging transition from a first surface spaced apart from a second surface, (c) a transition from a first surface, over and/or around an obstacle (e.g., a subassembly of a workpiece), and back to the first surface, (d) a transition from a first side of a workpiece around to a second side of a workpiece, and (e) a transition from a first workpiece. The utilization of the disclosed transition fixing apparatuses may also result in aesthetically pleasing elongated article-routing installations.

The transition fixing is operable to attach to a workpiece. A workpiece is a support surface or other structure to which a fixing may attach. Examples of workpieces include machines, cabinets, housings, frames, enclosures, vehicle chassis, panels, support beams, cable routing channels, conveyor frames, conveyor channel assemblies, frame rails, and the like. First and second workpieces referred to herein may be the same workpiece or may be different workpieces. A workpiece may include a support surface that is operable to support the transition fixing. A support surface may include a mount surface and/or a mount aperture defined therein (e.g., a slot, a channel, a bore, a threaded hole) and the like. The mount aperture may be operable to receive a mechanical fastener to attach the transition fixing to a support surface. In implementations described herein, a first support surface may be on a first workpiece and a second support surface may be on a second workpiece, and/or the first and second support surfaces may be on the same workpiece.

An elongated article may include one or more objects (e.g., components, wires, hoses, tubes, cables, conduit, and the like) and/or bundles thereof. The term “bundle” used herein refers to one or more elongated articles bundled together (e.g., bundled together by a strap). Common examples of bundles, which are securable via an example transition fixing, include bundles of wires, cables, lines, hoses, tubing, conduits, and/or other objects that need securing.

FIG. 1 is a schematic representation of an environment 100 in which aspects of transition fixing apparatuses may be implemented. The environment 100 includes a first workpiece 102 and a second workpiece 104. In the schematic representation of the environment 100, the first workpiece 102 attaches to the second workpiece 104 (e.g., through fasteners, not illustrated). In other aspects, the first workpiece 102 and the second workpiece 104 may be adjacent to, but not attached to, each other or may be spaced apart from one another. The first workpiece 102 illustrated in this schematic representation is a support beam 110 (e.g., aluminum extrusion, plastic extrusion, extruded channel rail) of a modular rail mounting system (e.g., an aluminum T-slotted framing system). In other aspects, the first workpiece 102 may be another type of workpiece described herein. The workpieces include support surfaces that are operable to support a transition fixing.

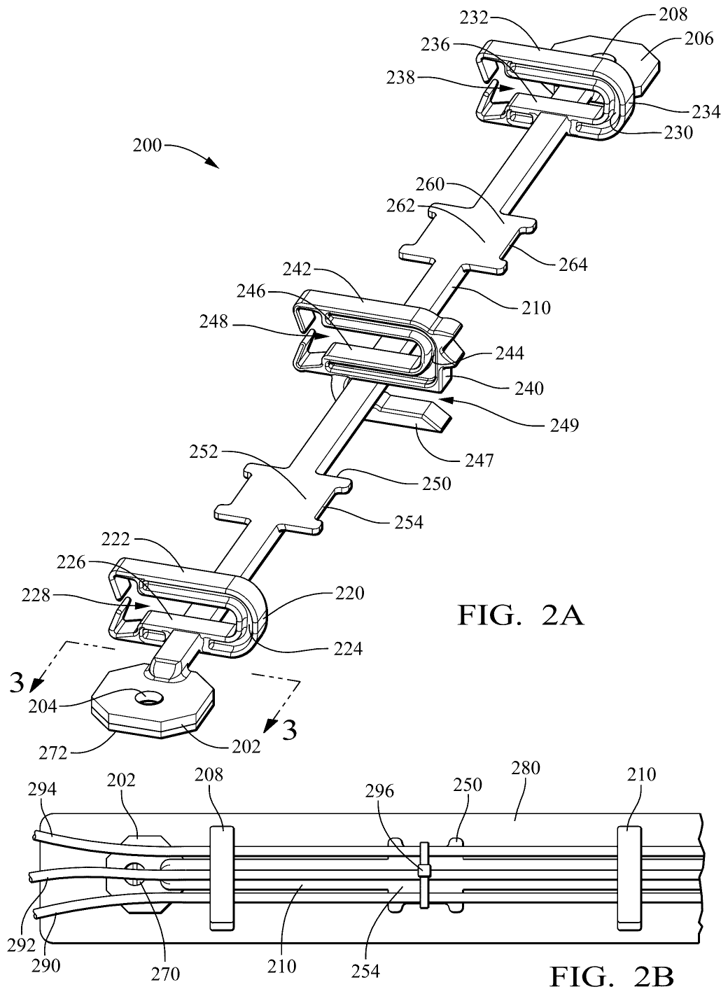

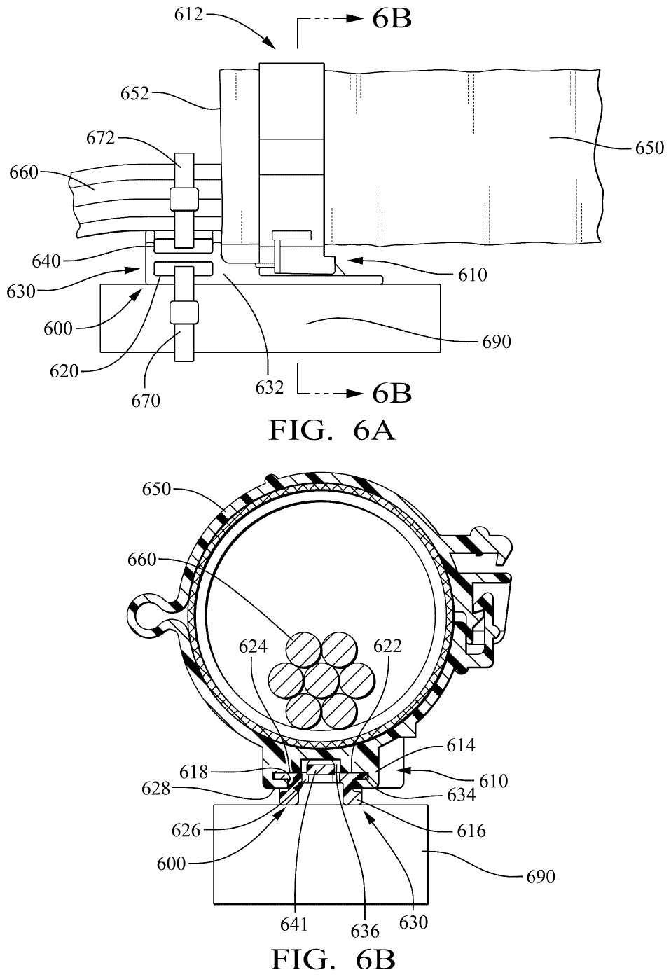

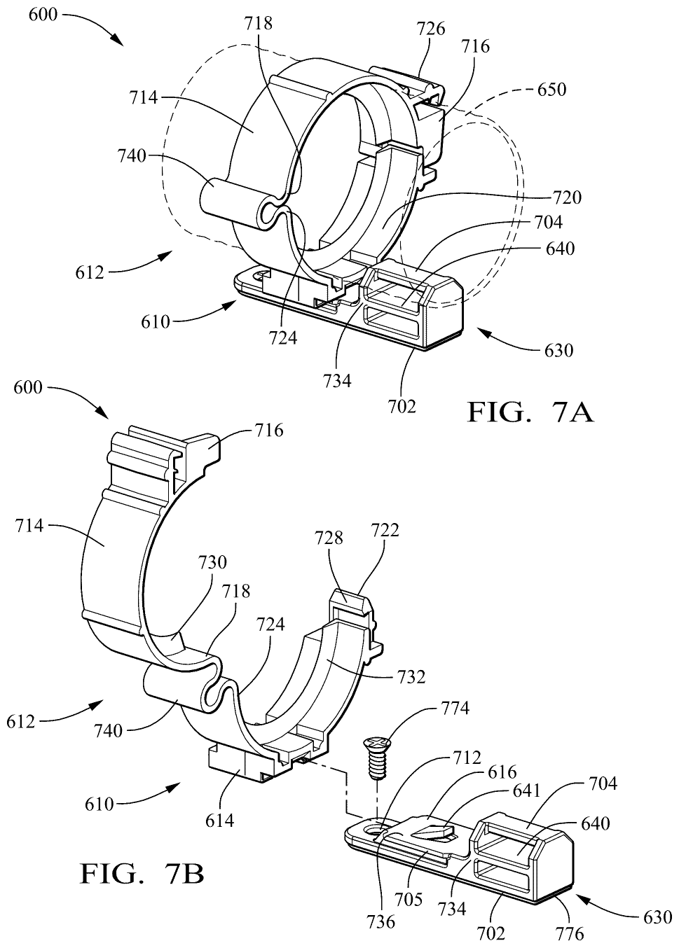

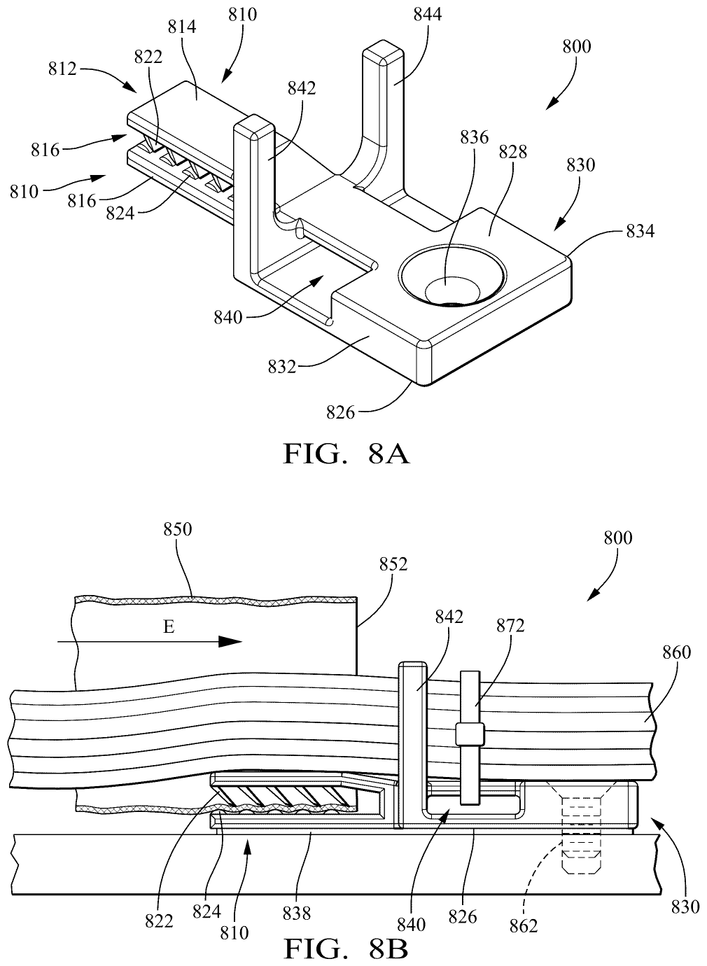

FIG. 1 includes three example implementations of transition fixings (e.g., transition fixing 130, transition fixing 150, transition fixing 170). Transition fixings (e.g., transition fixing 200, transition fixing 400) similar to the transition fixing 130 are further described below with respect to FIGS. 2A, 2B, 3, 4, 5A, and 5B, a transition fixing (e.g., transition fixing 600) similar to the transition fixing 150 is further described below with respect to FIGS. 6A, 6B, 7A, and 7B, and a transition fixing (e.g., transition fixing 800) similar to the transition fixing 170 is further described below with respect to FIGS. 8A and 8B. The transition fixings illustrated in FIG. 1 are merely examples of transition fixings and other examples can be created from combinations of one or more of the elements of these examples. Further, while these example transition fixings are illustrated in the positions shown in FIG. 1, in other implementations they may be located in other positions (e.g., a position where the transition fixing 170 is located between a first support surface 118 and a second support surface 120, and the like).

The first workpiece 102 (e.g., support beam 110) defines a first support surface 118 and a second support surface 120. In FIG. 1, the first support surface 118 and the second support surface 120 are perpendicular to one another. The second workpiece 104 defines a third support surface 122 and a fourth support surface 124. In FIG. 1, the third support surface 122 and the fourth support surface 124 are perpendicular to one another.

The transition fixings (e.g., transition fixing 130, transition fixing 150, transition fixing 170) may include one or more support connectors that are operable to attach to a support surface. In an example, the transition fixing 130 includes a first support connector 132 that is operable to attach to a support surface (e.g., first support surface 118), for example via a mechanical fastener, and a second support connector 134 that is operable to attach to a support surface (e.g., third support surface 122), for example via an adhesive fastener 144. In another example, a transition fixing (e.g., transition fixing 150) includes a support connector 152 that is operable to attach to a support surface (e.g., second support surface 120) and an attachment portion 154 that is operable to attach to a conduit 156. The conduit 156 may be a flexible conduit. In another example, a transition fixing (e.g., transition fixing 170) includes a support connector 172 that is operable to attach to a support surface (e.g., fourth support surface 124) and an attachment portion 174 that is operable to attach to a conduit 176 (e.g., a flexible conduit).

A support connector may include any common connection manner, including, but not limited to, a fastener (e.g., a blind hole fastener, a clamp fastener, a mechanical fastener, a T-nut fastener for a T-slot metal frame, an arrowhead fastener, a fir-tree fastener, a mounting edge clip, a twist-lock fastener that is configured for receipt into the slot of a rail, a weld stud mount, a cable attachment, a hose attachment), an adhesive fastener (e.g., double-sided adhesive tape), a friction fit, and the like, and combinations thereof (e.g., a mechanical fastener and an adhesive fastener). In implementations, a support connector may include an aperture (e.g., mount hole) that is defined through the support connector, which is operable to receive a fastener (e.g., a bolt, a screw) that engages a mount aperture (e.g., a bore) that is defined in the workpiece. In other implementations, a connector may be operable to engage an elongated fastener (e.g., a stud, a threaded bolt) that extends from the workpiece, may be operable to clamp onto an edge of the workpiece (e.g., through use of an edge clip), and/or the like. A support connector may be formed integrally with the flexible spine portion (described below) through an injection-molding process, an additive manufacturing process (e.g., a fused deposition modeling (FDM) process, a three-dimensional (3D) printing process), and/or another suitable process.

The transition fixing 150 may be included in a system that includes a second transition fixing (e.g., transition fixing 150′), which includes a second support connector 152′ that is operable to attach to a support surface (e.g., third support surface 122) and an attachment portion 154′ that is operable to attach to the conduit 156.

The transition fixing may be part of a system that includes a second transition fixing (e.g., transition fixing 170′), which includes a second support connector 172′ that is operable to attach to a support surface (e.g., fourth support surface 124) and an attachment portion 174′ that is operable to attach to an opposite end of the conduit 176. In such a configuration, the transition fixing 170 may be routed over and/or around an obstacle 190. A transition fixing (e.g., transition fixing 600) that is similar to the transition fixing 170 is further described below with respect to FIGS. 8A and 8B.

A transition fixing (e.g., transition fixing 150, transition fixing 170) may further include an attachment portion (e.g., attachment portion 154, attachment portion 174) that is operable to attach to a conduit (e.g., conduit 156, conduit 176). A transition fixing may be part of a system that includes a second transition fixing and a conduit. In a first example, the transition fixing 150 is included in a system that includes the second transition fixing 150′ with the second support connector 152′ that is operable to attach to a support surface (e.g., third support surface 122) and the attachment portion 154′ that is operable to attach to the conduit 156. In a second example, the transition fixing 170 is included in a system that includes the second transition fixing 170′ with the second support connector 172′ that is operable to attach to a support surface (e.g., fourth support surface 124) and the attachment portion 174′ that is operable to attach to the conduit 176. In some transition fixing applications, a transition fixing may be operable to split up elongated articles into different paths. In this way, a transition fixing may include multiple attachment portions (e.g., a plurality of attachment portions that are oriented (e.g., radially to one another, perpendicular to one another, parallel to one another, and the like) to form a branched transition fixing that is operable to route elongated objects in two or more directions).

A transition fixing may include a flexible spine portion (e.g., flexible spine portion 136 of transition fixing 130) that extends from at least one of the support connectors and/or attachment portions. For example, the transition fixing 130 includes a flexible spine portion 136, a transition fixing 200 includes a flexible spine portion 210, and a transition fixing 400 includes a flexible spine portion 420. Transition fixings (e.g., transition fixing 200, transition fixing 400) that are similar to the transition fixing 130 are further described below with respect to FIGS. 2A, 2B, 3, 4, 5A, and 5B.

Returning to FIG. 1, the flexible spine portion 136 includes a first end 140 that extends to a first support connector 132 and a second end 142 that extends to a second support connector 134. In this way, the flexible spine portion 136 extends between the first support connector 132 and the second support connector 134.

The flexible spine portion (e.g., flexible spine portion 136) may be configured to be positioned between the support surface and the elongated article to provide abrasion protection for the elongated article. For example, the flexible spine portion may be positioned between the elongated article and any sharp edges of a workpiece or environment that the elongated article may cross. A support connector may space the flexible spine portion from the support surface.

As described above, the flexible spine portion 136 may include a retainer portion 138 that is operable to receive and/or retain an elongated article (e.g., elongated article 126) to route the elongated article 126 (e.g., from the first support surface 118 to the third support surface 122). In implementations, the retainer portion 138 may attach to the elongated article 126. The flexible spine portion (e.g., flexible spine portion 136) may be a continuous piece that extends between the first support connector and the second support connector; in other implementations, the flexible spine portion may be in two or more segments located between support connectors and/or one or more retainer portions.

A retainer portion (e.g., retainer portion 138) may include a wirehold, a wire holder, a mount, a clip mount, a clamp mount, a stacked organizer, a cradle, a cradle mount, a saddle mount, and the like. A retainer portion may hold a routed elongated article in place without any straps, which may speed the installation process and allow a technician to create an aesthetically clean and professional-looking elongated article pathway (e.g., wire pathway). In implementations, a retainer portion may not be present. A retainer portion may be formed integrally with the flexible spine portion through an injection-molding process, an additive manufacturing process (e.g., an FDM process, a 3D printing process), and/or another suitable process.

The flexible spine portion may be operable to be bendable and/or shapeable, for example in one or more of an X-axis direction (e.g., a thickness of the flexible spine portion), a Y-axis direction (e.g., a width of the flexible spine portion), or a Z-axis direction (e.g., a length of the flexible spine portion). This flexibility may permit the technician to flexibly alter a shape of the transition fixing, for example, to enable the technician to position the flexible spine portion between another object (e.g., obstacle, sharp edge) and the elongated article and thereby provide protection (e.g., from abrasion) for the elongated article. After the technician so positions the transition fixing, the technician may then secure the flexible spine portion relative to the workpiece(s) via the one or more support connectors. The flexible spine portion may be operable to resist bending in a direction (e.g., in the Y-axis direction).

A transition fixing may include a conduit (e.g., conduit 156 of transition fixing 150, conduit 176 of transition fixing 170, conduit 650 of transition fixing 600, conduit 850 of transition fixing 800). The conduit may be a flexible conduit. The conduit 156 of the transition fixing 150 is similar to the transition fixing 600 described with respect to FIGS. 6A, 6B, 7A, and 7B and the conduit 176 of the transition fixing 170 is similar to the transition fixing 800 described with respect to FIGS. 8A and 8B. The conduit may be operable to route and/or protect an elongated article (e.g., wire bundle). Examples of conduits include flexible conduits, bendable conduits, fabric conduits, flexible ducts, braided sleeves, protective tubing, protective sheathing, flexible conduits, cylindrical tubing, convoluted tubing, wire wrap, spiral wrap, rigid conduits, and the like.

In implementations, the conduit includes a continuous strip of material that is operable to extend from the first support connector to a second support connector. In one example, the conduit 156 includes a first end 158 that connects to the first attachment portion 154 and a second end 160 that extends to the second attachment portion 154′. In this way, the conduit 156 extends between the first attachment portion 154 and the second attachment portion 154′. In another example, the conduit 176 of the transition fixing 170 includes a first end 178 that connects to the first attachment portion 174 and a second end 180 that may extend to the second attachment portion 174′. In this way, the conduit 176 extends between the first attachment portion 174 and the second attachment portion 174′.

The conduit (e.g., conduit 156, conduit 176) may be configured to be positioned between the support surface and the elongated article to provide abrasion protection for the elongated article. For example, the conduit may be positioned between the elongated article and any sharp edges of a workpiece or environment through which the elongated article is routed. In implementations, a conduit may include a longitudinal slit down at least a portion of the length of the conduit or a spiral wrap (e.g., in a spiral wrap implementation) may include a helical or arcuate slit that runs around and down the entire length of the conduit. In such configurations, the conduit may be operable to be installed over a routed elongated article (e.g., wire bundle(s)) and secured to the transition fixing before and/or after the transition fixing is secured to the mounting support surface (e.g., workpiece).

As used herein, the use of the terms “flexible” and “bendable” indicates that the described element is capable of repeated bending such that it may be bent into different shapes and does not retain a general shape but instead readily deforms when force is applied, unless the context clearly indicates otherwise. As used herein, the use of the term “shapeable” indicates that the described element is capable of being shaped, bent, and/or modeled by a shaping operation from a first shape to a second shape (e.g., a bent shape) that will be retained unless further shaping operations are performed, unless the context clearly indicates otherwise.

FIGS. 2A, 2B, and 3 illustrate an example transition fixing 200. The transition fixing 200 is similar to the transition fixing 130, illustrated in FIG. 1 and described above, except as detailed below. Thus, the transition fixing 200 includes a mount portion (e.g., support connector 202 (first support connector), support connector 206 (second support connector)) configured for attachment to a support surface (e.g., support surface 280) of a workpiece. In aspects, this connection is through a connector portion (e.g., connector portion 204, connector portion 208). As illustrated in FIG. 2A, the connector portions (e.g., connector portion 204, connector portion 208) are apertures defined through the respective mount portion. The apertures are operable to receive a fastener (e.g., a threaded screw 270, a bolt) therethrough, which engages the support surface of the workpiece (e.g., engages a mount aperture defined in the workpiece) to attach the support connector to the support surface. In another example, the connector may be a screw attachment that fastens with a screw and T-nut (e.g., Tee nut) to the workpiece (e.g., a #8 (M4) screw that is configured for attachment into a panel surface or with a T-nut in frame). In another example, the mount section may utilize an adhesive fastener 272 (e.g., adhesive fastener 144 of FIG. 1) to mount to the mounting surface of the workpiece and the connector may be a surface of the mount section to which the adhesive fastener 272 is applied. The adhesive fastener 272 may be a double-sided adhesive tape, a double-stick adhesive foam, a pressure-sensitive adhesive tape, and the like. In other aspects, the workpiece may attach to the transition fixing 200 via an elongated fastener (e.g., a stud, a threaded bolt) that extends from the workpiece, by the mount section clamping onto an edge of the workpiece, and the like.

The support connector 202 is operable to attach to a support surface (e.g., first support surface 118 of FIG. 1) and the support connector 206 is operable to attach to a support surface (e.g., third support surface 122 of FIG. 1). The support surfaces may be the same support surface. A flexible spine portion 210 extends between the support connector 202 and the support connector 206.

The transition fixing 200 may further include at least one retainer portion (e.g., retainer portion 220, retainer portion 230, retainer portion 240, retainer portion 250, retainer portion 260). A retainer portion is operable to retain at least one elongated article (e.g., elongated article 290, elongated article 292, elongated article 294) to route the elongated article along a support surface and/or from a first support surface to a second support surface.

In implementations, a retainer portion (e.g., retainer portion 220, retainer portion 230, retainer portion 240) may include a pair of cradle arms (e.g., first cradle arm, second cradle arm) that are spaced apart by a base portion to define a cradle portion (e.g., open-ended cradle) therebetween. For example, in the aspect illustrated in FIG. 2A, the retainer portion 220 includes a pair of cradle arms (e.g., cradle arm 222, cradle arm 226) that are spaced apart by a base portion 224 to define a cradle portion 228 therebetween; the retainer portion 230 includes a pair of cradle arms (e.g., cradle arm 232, cradle arm 236) that are spaced apart by a base portion 234 to define a cradle portion 238 therebetween; and the retainer portion 240 includes a pair of cradle arms (e.g., cradle arm 242, cradle arm 246) that are spaced apart by a base portion 244 to define a cradle portion 248 therebetween. A cradle portion is operable to temporarily hold (e.g., by cradling) one or more elongated articles adjacent to a mount location (e.g., on a workpiece) while a technician routes the elongated articles along a route path. A cradle portion may be oriented parallel to the length of the flexible spine portion. In aspects, the cradle portion is U-shaped.

A retainer portion may be integral to the flexible spine portion 210, as illustrated with respect to the retainer portion 220, retainer portion 230, retainer portion 250, and retainer portion 260. For example, a retainer portion may be integrally formed together with the flexible spine portion 210 through an injection-molding process, an additive manufacturing process (e.g., an FDM process, a 3D printing process), and/or another suitable process. In implementations, a retainer portion may be attachable to (e.g., removably connected to) and detachable from (e.g., removably disconnected from) the flexible spine portion 210, as illustrated with respect to the retainer portion 240, which includes an attachment arm 247 spaced apart from the cradle arm 246 to define a conduit 249 that is configured to slide onto the flexible spine portion 210, with a mechanical connection (e.g., clamp, clip, snap, mechanical fastener), a welded connection, an adhesive connection, a friction fit, and/or the like that holds the retainer portion 240 on the flexible spine portion 210. In this way, a retainer portion may be removable from the flexible spine portion 210.

In implementations, a retainer portion (e.g., retainer portion 250, retainer portion 260) may include a stay portion (e.g., stay 252, stay 262) operable to support the elongated article and at least one notched portion (e.g., notched portion 254, notched portion 264) that is operable to receive a strap to attach the elongated article to the stay portion. In FIG. 2B, the stay 252 of the retainer portion 250 is operable to support the elongated articles (e.g., elongated article 290, elongated article 292, elongated article 294) spaced apart from the support surface 280. In FIG. 2B, the notched portion 254 retains the strap (e.g., cable tie 296) on the retainer portion 250, with ears of the retainer portion 250 limiting the strap from sliding off the retainer portion 250.

The term “strap” used herein refers to a strapping material, a cable tie, a hook-and-loop fastening strap, a plastic band, a metal band, string, twine, a wire, and the like, which is utilized to attach one or more elongated articles together into one or more bundles and/or to attach one or more elongated articles to a transition fixing. In aspects, the strap is a cable tie that includes a head end and a tail end. The head end includes a lock head and the tail end includes an elongated strap that extends from the lock head. The elongated strap may be configured for insertion through the lock head to form a loop (e.g., a loop around an elongated article and/or bundle of elongated articles). The lock head may include a pawl mechanism configured to engage strap serrations defined on the elongated strap, thereby retaining the elongated strap relative to the lock head.

In such a configuration, the technician can mount the mount portion(s) (e.g., support connector 202, support connector 206) to one or more of the support surface(s) (e.g., support surface 118, support surface 120, support surface 122, support surface 124, support surface 280). The technician can, before and/or after mounting the mount portion(s), route elongated articles through the cradles of the retainer portions (e.g., retainer portion 220, retainer portion 230, retainer portion 240) and across the stay portion (e.g., stay 252, stay 262). The technician can then insert a strap to pass under the stay portion, loop it over the elongated article(s), and connect the strap (e.g., the ends of the strap) together to bundle the elongated article(s) on the stay portion(s).

FIG. 3 is a cross-sectional view, along lines 3-3 in FIG. 2B, of the flexible spine portion 210. The flexible spine portion (e.g., flexible spine portion 210) may be formed of material that includes a shapeable material that is operable to retain a bent shape after bending. For example, the flexible spine portion 210 may include a core 302 that is bendable and/or shapeable, which allows the flexible spine portion 210 to be shape-formed. To express it another way, the flexible spine portion 210 is operable to be bendable into a bent shape. The incorporation of shapeable material (e.g., in the core 302) may allow for the bending of the flexible spine portion 210 and may allow the flexible spine portion 210 to maintain a bent shape (e.g., hold a bent form across a transition area from a first support surface of a first workpiece to a second support surface of a second workpiece). In an example, the support connector 202 is positioned in a first plane and the support connector 206 is positioned in a second plane when the flexible spine portion 210 is in its bent shape. The first plane and the second plane may be different planes. The flexible spine portion (e.g., the core 302 of the flexible spine portion) may also be operable to form a bend radius (e.g., maintain a minimum bend radius recommended by a manufacturer) for the route path of the elongated articles. In this way, damage to the elongated articles and/or loss of data transmission may be prevented.

The flexible spine portion (e.g., flexible spine portion 210) may include an overmolded portion 304 that is overmolded onto the core 302. The core 302 may be formed of a metal rod, a metal wire, a shapeable material, and the like. In such a configuration, the core (e.g., core 302) may have a stiffness greater than a stiffness of the overmolded portion (e.g., overmolded portion 304). In the implementation illustrated in FIG. 3, the core 302 is a metal material and the overmolded portion 304 is a polymeric material, which is formed around the core 302. In aspects, the flexible spine portion 210 may include at least one of a polymeric material overmolded onto the shapeable material and the shapeable material includes a polymer; a polymeric material overmolded onto the shapeable material and the shapeable material includes a metal; and/or the shapeable material and the shapeable material includes a shapeable polymeric material. The polymeric material may be a shock-absorbing polymeric material.

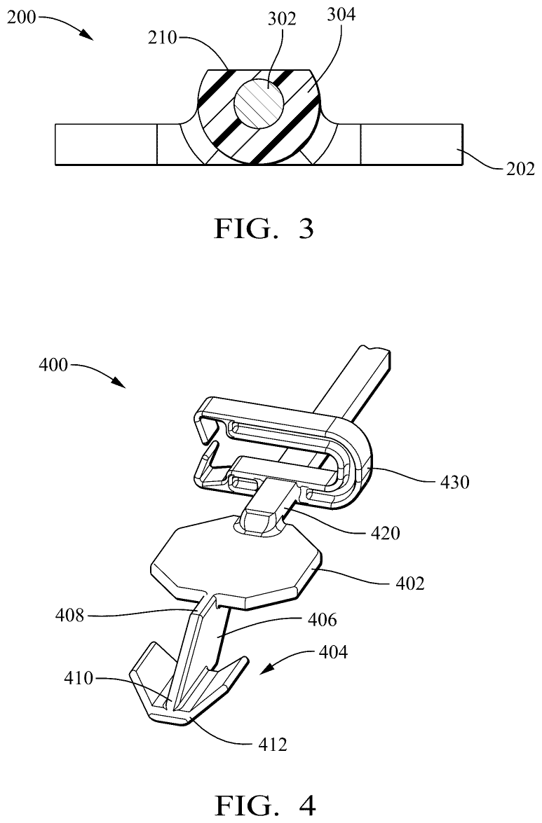

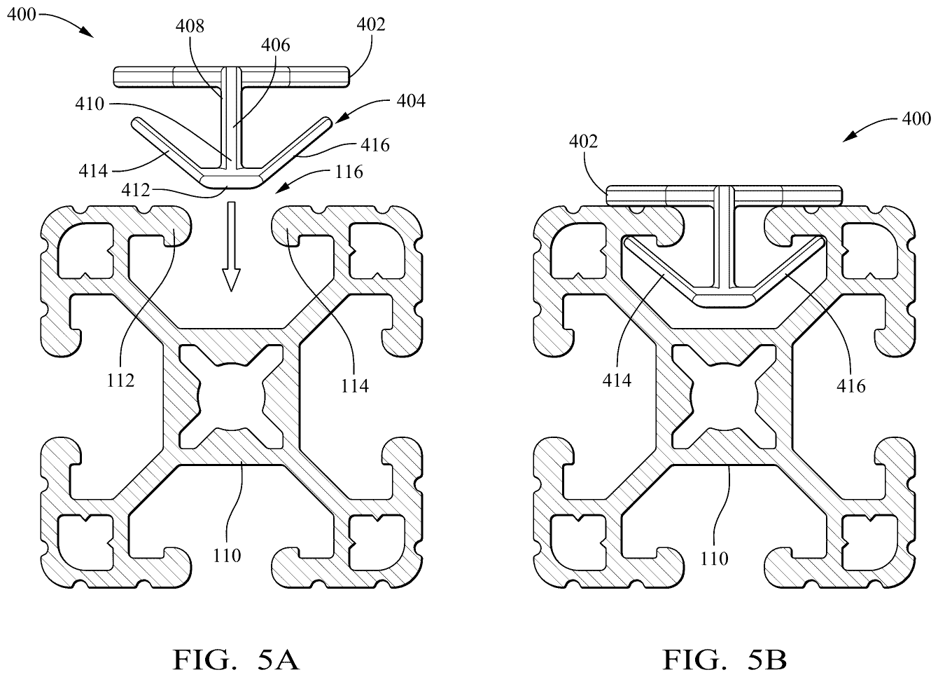

FIGS. 4, 5A, and 5B illustrate another example transition fixing 400. The transition fixing 400 is similar to the transition fixings (e.g., transition fixing 130, transition fixing 200) illustrated in FIGS. 1-3 and described above, except as detailed below. Thus, the transition fixing 400 includes at least one mount portion (e.g., support connector 402) configured for attachment to a support surface (e.g., support surface 118) of a workpiece, a flexible spine portion 420 that is operable to route an elongated article from a first support surface to a second support surface, and a retainer portion 430 that is operable to retain an elongated article.

In the schematic representation illustrated in FIG. 1, the first workpiece 102 is a support beam 110 (e.g., aluminum extrusion, plastic extrusion, extruded channel rail) of a modular rail mounting system (e.g., an aluminum T-slotted framing system). The support beam 110 includes a support surface 118 that is operable to support the transition fixing 400. The support beam 110 includes a pair of spaced apart side rails (e.g., side rail 112, side rail 114) that define a lock channel 116 (e.g., a channel, a T-shaped slot) therebetween and in the support surface 118, as illustrated in FIGS. 5A and 5B.

The support connector 402 includes a connector portion 404 that is operable to extend into the lock channel 116. The connector portion 404 includes a stem portion 406 that includes a stem first end 408 that is opposite a stem second end 410. The stem first end 408 extends from the flexible spine portion 420 and the stem second end 410 further includes a head portion 412 that is spaced apart from the flexible spine portion 420. The head portion 412 may include at least one outwardly extending flange (e.g., flange 414, flange 416) that is configured for deflection in a direction of the stem portion 406 upon insertion of head portion 412 into the lock channel 116. Upon the flange passing the ends of the side rail 112 and the side rail 114 and into the lock channel 116, the flange deflects back in a direction opposite of the stem portion 406 to resist withdrawal of the head portion 412 from the lock channel 116. In such a configuration, the head portion 412 has a width that is greater than a width of the lock channel 116, so as to lock the head portion 412 within the lock channel 116, as illustrated in FIG. 5B. In such a configuration, the connector portion 404 of the support connector 402 is configured for receipt into a T-shaped slot (e.g., by pressing into the T-shaped slot, as illustrated in FIGS. 5A and 5B). In some transition fixing implementations, a threaded “T” nut, a threaded twist n′ lock, and/or other components may be used to secure a support connector and/or transition fixing to the channel T-slot.

FIGS. 6A, 6B, 7A, and 7B illustrate an example transition fixing 600. The transition fixing 600 is similar to the transition fixing 150, illustrated in FIG. 1 and described above, except as detailed below. Thus, the transition fixing 600 includes an attachment portion 610 and a support connector 630 that extends from the attachment portion 610.

The attachment portion 610 is operable to attach to a conduit 650 (e.g., at a first end 652 of the conduit 650), which routes and/or protects elongated articles 660. The conduit 650 may be a flexible conduit, a bendable conduit, a fabric conduit, a flexible duct, a braided sleeve, protective tubing, protective sheathing, cylindrical tubing, convoluted tubing, a wire wrap, a spiral wrap, a rigid conduit, and the like. In the implementation illustrated in FIGS. 6A, 6B, 7A, and 7B, the conduit 650 is flexible convoluted tubing, through which an elongated article 660 is routed. The attachment portion 610 includes a clamp portion 612 operable to clamp onto the conduit 650 (e.g., at the first end 652 of the conduit 650) to attach the attachment portion 610 to the conduit 650.

The clamp portion 612 includes a first connector 714 (e.g., first clamp member) that has a first side 716 opposite a second side 718, a second connector 720 (e.g., second clamp member) that has a first side 722 opposite a second side 724, and a hinge member 740 that hingedly connects the second side 718 of the first connector 714 to the second side 724 of the second connector 720. The first side 716 of the first connector 714 includes a first lock mechanism 726 and the first side 722 of the second connector 720 includes a second lock mechanism 728. The first and second lock mechanisms are configured to lock a position of respective first ends of the first and second connectors together around the conduit 650 with the conduit 650 in a passageway defined between the first and second connectors. The first connector 714 and/or the second connector 720 may include a rib (e.g., rib 730, rib 732) operable to engage the conduit 650 (e.g., in a trough defined in the conduit 650).

The support connector 630 includes a base portion 702 that is spaced apart from a platform portion 704, the platform portion 704 operable to support at least a portion of an elongated article 660 that extends from the conduit 650. In aspects, the platform portion 704 is spaced apart from the base portion 702 of the support connector 630 to position the platform portion 704 in a plane generally parallel to a plane of the conduit 650 to support the elongated article 660. The support connector 630 may include a strap passage 640 that is operable to receive a strap (e.g., cable tie 672) therethrough.

The support connector 630 is operable to attach the transition fixing 600 to a support surface 690. In a first example, the support connector 630 is an aperture 712 defined therethrough, which is operable to receive a mechanical fastener (not illustrated) therethrough to attach the support connector 630 to the support surface 690. In a second example, the support connector 630 includes a base portion 702 operable to attach to the support surface 690, for example through an adhesive portion 776 (e.g., the adhesive fastener 144 of FIG. 1). In a third example, the support connector 630 includes a strap passage 620 (e.g., saddle slot) defined therethrough, which is operable to receive a strap (e.g., cable tie 670) to attach the support connector 630 to the support surface 690. The strap passage 620 extends from a first side portion 632 to a second side portion 734.

The support connector 630 may include the first side portion 632 spaced apart from the second side portion 734 and defines a strap passage 640 that extends from the first side portion 632 to the second side portion 734. The strap passage 640 is operable to receive a strap (e.g., cable tie 672) therethrough to attach the support connector 630 to an elongated article 660 that extends out of the conduit 650 (e.g., to attach the platform portion 704 of the support connector 630 to the elongated article 660 that extends out of the conduit 650).

In implementations, the support connector 630 is releasably attached to the attachment portion 610 via an interlock mechanism. For example, in the aspect illustrated in FIGS. 6A, 6B, 7A, and 7B, the support connector 630 includes a first releasable connector 616 and the attachment portion 610 includes a second releasable connector 614, which are operable to interact to releasably connect the support connector 630 to the attachment portion 610. This releasable connection enables the attachment portion 610 to be attached to and detached from the support connector 630.

The second releasable connector 614 defines an insert channel 626 that is operable to receive a mount attachment 634 of the first releasable connector 616. The insert channel 626 includes a slot 618 (e.g., an elongated T-slot) defined in a bottom side 628 of the second releasable connector 614. The slot 618 is open at a first end and may be closed at a second end. The insert channel 626 includes a pair of laterally extending flanges (first flange 622, second flange 624), which define the slot 618. The slot 618 is configured to receive the mount attachment 634 of the first releasable connector 616 therein. In the aspect illustrated in FIGS. 6B and 7B, a retention tab 641 extends upwards from a base surface 736 of the first releasable connector 616. The retention tab 641 is operable to engage a receiver 636 defined in the insert channel 626 to lock the first releasable connector 616 to the second releasable connector 614. In aspects, the interlock mechanism includes the retention tab 641 and the receiver 636.

The transition fixing 600 may be included in a system that includes a second transition fixing (not illustrated) that is operable to attach to a second support surface (not illustrated). For example, as illustrated in FIG. 1 with respect to the transition fixing 150, which includes the conduit 156 that extends between the transition fixing 150 that includes the first attachment portion 154 and the second transition fixing 150′ that includes the second attachment portion 154′, the first attachment portion 154 attaches to the conduit 156 at the first end 158 and the second attachment portion 154′ attaches to the conduit 156 at the second end 160.

FIGS. 8A and 8B illustrate another example transition fixing 800. The transition fixing 800 is similar to the transition fixings (e.g., transition fixing 170, transition fixing 600) illustrated in FIGS. 1, 6A, 6B, 6C, 7A, and 7B and described above, except as detailed below. Thus, the transition fixing 800 includes an attachment portion 810 and a support connector 830 that extends from the attachment portion 810.

The attachment portion 810 is operable to attach to a conduit 850 (e.g., at a first end 852 of the conduit 850). The conduit 850 routes and/or protects an elongated article 860 (e.g., wire bundle). The conduit 850 may be a flexible conduit, a bendable conduit, a fabric conduit, a flexible duct, a braided sleeve, protective tubing, protective sheathing, cylindrical tubing, convoluted tubing, a wire wrap, a spiral wrap, a rigid conduit, and the like. In the implementation illustrated in FIGS. 8A and 8B, the conduit 850 is a flexible braided sleeve, through which an elongated article 860 is routed.

The attachment portion 810 includes a clip portion 812 operable to clip onto the conduit 850 (e.g., at a first end 852 of the conduit 850) to attach the attachment portion 810 of the transition fixing 800 to the conduit 850. The clip portion 812 includes a pair of spaced-apart sidewalls (e.g., sidewall 814, sidewall 816) that define a gap 818 therebetween. In implementations, a clip portion may include a U-shaped clip that has sidewalls with sufficient elasticity to be able to resiliently, if not elastically, deform outward to contact a target object. A sidewall (e.g., an opposing jaw) may include at least one retainer portion that extends from the sidewall and into the gap 818. The retainer portion is operable to retain the conduit 850 in the gap 818. In the implementation illustrated in FIGS. 8A and 8B, the retainer portion includes latch teeth 822 that extend from the sidewall 814 and into the gap 818 and/or a plurality of latch ridges (e.g., latch ridge 824) that extend from the sidewall 816 and into the gap 818. Opposing latch teeth 822 and latch ridges 824 may cooperate to retain the conduit 850 (e.g., first end 852 of the conduit 850) in the gap 818. A latch tooth of the latch teeth 822 may extend at an angle oblique to a length of a sidewall. A latch tooth may pierce the conduit 850 and mechanically attach to a latch ridge, for example, through an interlocking snap-fit connection, through a hook portion defined in the latch tooth, and the like.

When the first end 852 of the conduit 850 is introduced into the gap 818 in an insertion direction E, the retainer portion (e.g., latch teeth 822, latch ridge 824) is operable to prevent the first end 852 from slipping out of the gap 818 counter to the insertion direction. The sidewalls (e.g., sidewall 814, sidewall 816) may be formed integrally (e.g., injection-molded) with each other. The retainer portion (e.g., latch teeth 822, latch ridge 824) may be integrally formed (e.g., injection-molded) with the respective sidewall. Retainer portions on a first sidewall may be offset in an alternating order with retainer portions on an opposing sidewall. A retainer portion may protrude into the gap 818 farther than a center plane of the gap 818 that is equally distant from both of the sidewalls.

The support connector 830 is operable to attach the transition fixing 800 to a support surface 890. The support connector 830 extends from the attachment portion 810. In a first example, the support connector 830 includes an aperture 836 defined therethrough, which is operable to receive a mechanical fastener 862 to attach the support connector 830 to the support surface 890. In a second example, the support connector 830 includes a base portion 826 that is operable to attach to the support surface 890, for example, through an adhesive portion 838 (e.g., the adhesive fastener 144 of FIG. 1). In a third example, the support connector 830 includes a first side portion 832 spaced apart from a second side portion 834 and defines a strap passage (e.g., strap passage 840) that extends from the first side portion 832 to the second side portion 834. The strap passage 840 may be operable to receive a strap (e.g., cable tie) to attach the support connector 830 to the support surface 890 (e.g., as is illustrated in FIG. 6A with respect to the strap passage 620 and cable tie 670).

The support connector 830 includes a base portion 826 that is spaced apart from a platform portion 828. The platform portion 828 is operable to support at least a portion of an elongated article 860 that extends from the conduit 850. In aspects, the platform portion 828 is spaced apart from the base portion 826 of the support connector 830 to position the platform portion 828 in a plane generally parallel to a plane of the conduit 850 to support the elongated article 860. The support connector 830 may include a strap passage 840 that is operable to receive a strap (e.g., cable tie 872) therethrough to attach the platform portion 828 of the support connector 830 to the elongated article 860 that extends out of the conduit 850. In aspects, the location where the cable tie 872 secures the elongated article 860 to the platform portion 828 may define where the transition area begins or ends. Many elongated article bundles have resistance to bending and a strap (e.g., cable tie 872) that secures the bundle to the platform portion may begin and/or define a new trajectory of the bundle. In this way, the strap may retain the bundle against the platform portion near the point where the bundle enters the conduit (e.g., at a first end 852 of the conduit 850), such as, where the bundle is bending around a curve and there is bundle resistance to the bending. In such a case, the bundle bending resistance may need to be restrained (e.g., with a strap) to better route the bundle in an organized manner.

The support connector 830 may further include guide arms (e.g., guide arm 842, guide arm 844) that are operable to receive the elongated article 860 therebetween to position the elongated article 860 for bundling. The guide arms may define a cradle therebetween. The aspect illustrated in FIGS. 2A-5B may also include guide arms that are operable to guide the elongated articles relative to the flexible spine portion 210. The aspect illustrated in FIGS. 6A-7B may also include guide arms that are operable to receive the elongated articles 660 therebetween and position them for bundling.

The transition fixing 800 may be included in a system that includes a second transition fixing (not illustrated) that is operable to attach to a second support surface (not illustrated). For example, as illustrated in FIG. 1 with respect to the transition fixing 170, which includes the conduit 176 that extends between the transition fixing 170 that includes the first attachment portion 174 and the second transition fixing 170′ that includes the second attachment portion 174′, the first attachment portion 174 attaches to the conduit 176 at the first end 178 and the second attachment portion 174′ attaches to the conduit 176 at the second end 180. In implementations, a transition fixing (e.g., transition fixing 600, transition fixing 800) is utilized in a system that also includes at least one of an elongated article, a workpiece, a strap (e.g., cable tie), a conduit (e.g., a flexible conduit), another transition fixing, and the like.

One or more of the components of the disclosed transition fixing apparatuses may be integrally formed of a suitable material(s) through one or more of an injection-molding process, an additive manufacturing process (e.g., an FDM process, a 3D printing process), and/or another suitable process. The components of the disclosed transition fixing apparatuses may be fabricated of any suitable material, including, but not limited to, a metal (e.g., wire), a polymer (e.g., a polymeric material), and/or a composite. Suitable polymeric materials may include one or more of polyamide (PA), polypropylene (PP), polyethylene (PE), polyphenylene sulfide (PPS), polyether ether ketone (PEEK), polyaryletherketone (PAEK), ethylene tetrafluoroethylene (ETFE), polyacetal (POM), polybutylene terephthalate (PBT), ultraviolet stabilized polyacetal (POMUV), acrylonitrile styrene acrylate (ASA), cross-linked thermoplastics, partially cross-linked thermoplastics, higher-temperature resins, ultraviolet (UV) resistant resins, other thermoplastic materials, and the like, and copolymers, blends, and/or alloys thereof, as well as fiber reinforced materials. A suitable polymeric material may include one or more additives (e.g., heat stabilizers (e.g., copper iodide), impact modifiers (e.g., polyolefin, urethane, rubber), UV stabilizers (e.g., carbon black, hindered amine light stabilizers (HALS)), flame retardants (e.g., nitrogen-based halogen-free flame retardants, melamine cyanurate, melamine borate, ammonium polyphosphate), colorants, and the like). One or more of the components of the disclosed transition fixing apparatuses may be formed of the same material as the other components, and/or of a different material than the other components.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Some additional examples of transition fixing apparatuses are as follows:
Example 1. An apparatus comprising: a first support connector operable to attach to a first support surface; a second support connector operable to attach to a second support surface; and a flexible spine portion extending between the first support connector and the second support connector, the flexible spine portion including a retainer portion operable to retain an elongated article, the flexible spine portion operable to route the elongated article from the first support surface to the second support surface.
Example 2. The apparatus of Example 1, wherein the flexible spine portion is operable to be bendable into a bent shape, and wherein in the bent shape the first support connector is positioned in a first plane and the second support connector is positioned in a second plane.
Example 3. The apparatus of Example 2, wherein the flexible spine portion further comprises a shapeable material operable to retain the bent shape after bending.
Example 4. The apparatus of Example 3, wherein the flexible spine portion further comprises at least one of: a polymeric material overmolded onto the shapeable material, wherein the shapeable material comprises a polymer or a metal;

or the shapeable material, wherein the shapeable material comprises a shapeable polymeric material.
Example 5. The apparatus of Example 1, wherein the retainer portion further comprises: a cradle portion defined on the flexible spine portion, the cradle portion defining a cradle that is operable to receive the elongated article therethrough.
Example 6. The apparatus of Example 1, wherein the retainer portion further comprises: a cradle portion removably connected to the flexible spine portion, the cradle portion defining a cradle that is operable to receive the elongated article therethrough.
Example 7. The apparatus of Example 1, wherein the first support connector further comprises: a connector portion operable to extend into a lock channel defined in the first support surface, the connector portion further comprising: a stem portion having a stem first end opposite a stem second end, the stem first end extending from the flexible spine portion, and the stem second end comprising a head portion that is spaced apart from the flexible spine portion, wherein a width of the head portion is greater than a width of the lock channel.
Example 8. The apparatus of Example 1, wherein the retainer portion further comprises: a stay portion operable to support the elongated article; and a notched portion operable to receive a strap to attach the elongated article to the stay portion.
Example 9. An apparatus comprising: an attachment portion operable to attach to a first end of a conduit, the attachment portion including a clip portion operable to clip onto the first end of the conduit to attach the attachment portion to the first end of the conduit; and a support connector operable to attach to a support surface, the support connector extending from the attachment portion.
Example 10. The apparatus of Example 9, wherein the support connector is operable to attach the support connector to the support surface, and wherein the support connector defines an aperture that is operable to receive a mechanical fastener therethrough to attach the support connector to the support surface.
Example 11. The apparatus of Example 9, wherein the support connector includes a first side portion spaced apart from a second side portion, wherein the support connector defines a strap passage that extends from the first side portion to the second side portion, and wherein the strap passage is operable to receive a strap therethrough to attach the support connector to an elongated article that extends out of the conduit.
Example 12. The apparatus of Example 11, wherein the support connector includes a platform portion operable to support a portion of the elongated article that extends out of the conduit, and wherein the strap passage is operable to receive the strap therethrough to attach the platform portion of the support connector to the elongated article that extends out of the conduit.
Example 13. The apparatus of Example 12, wherein the platform portion is spaced apart from a base portion of the support connector to position the platform portion in a plane generally parallel to a plane of the conduit.
Example 14. The apparatus of Example 9, wherein the support connector further comprises: at least two guide arms operable to receive an elongated article therebetween.
Example 15. An apparatus comprising: an attachment portion operable to attach to a first end of a conduit, the attachment portion including a clamp portion operable to clamp onto the first end of the conduit to attach the attachment portion to the first end of the conduit; and a support connector operable to attach to a support surface, the support connector extending from the attachment portion.
Example 16. The apparatus of Example 15, wherein the support connector includes a base portion spaced apart from a platform portion, wherein the support connector defines an aperture that extends between the base portion and the platform portion, and wherein the aperture is operable to receive a mechanical fastener therethrough to attach the support connector to the support surface.
Example 17. The apparatus of Example 15, wherein the support connector includes a first side portion spaced apart from a second side portion, wherein the support connector defines a strap passage that extends from the first side portion to the second side portion, and wherein the strap passage is operable to receive a strap therethrough to attach the support connector to the support surface.
Example 18. The apparatus of Example 15, wherein the support connector includes a first side portion spaced apart from a second side portion, wherein the support connector defines a strap passage that extends from the first side portion to the second side portion, and wherein the strap passage is operable to receive a strap therethrough to attach the support connector to an elongated article that extends out of the conduit.
Example 19. The apparatus of Example 18, wherein the support connector includes a platform portion operable to support a portion of the elongated article that extends out of the conduit, and wherein the strap passage is operable to receive the strap therethrough to attach the platform portion of the support connector to the elongated article that extends out of the conduit.
Example 20. The apparatus of Example 19, wherein the platform portion is spaced apart from a base portion of the support connector to position the platform portion in a plane generally parallel to a plane of the conduit.

In aspects, a transition fixing apparatus may include one or more of the features of the transition fixing apparatuses illustrated in the Drawings and described above. Although implementations for transition fixing apparatuses have been described in language specific to certain features and/or methods, the subject of this description is not necessarily limited to the specific features or methods described. Rather, the specific features and methods are disclosed as example implementations for transition fixing apparatuses.

What is claimed is:

1. An apparatus comprising:
a first support connector operable to attach to a first support surface;
a second support connector operable to attach to a second support surface; and
a flexible spine portion extending between the first support connector and the second support connector, the flexible spine portion including a retainer portion operable to retain an elongated article, the flexible spine portion operable to route the elongated article from the first support surface to the second support surface.

2. The apparatus of claim 1,
wherein the flexible spine portion is operable to be bendable into a bent shape, and
wherein in the bent shape the first support connector is positioned in a first plane and the second support connector is positioned in a second plane.

3. The apparatus of claim 2, wherein the flexible spine portion further comprises a shapeable material operable to retain the bent shape after bending.

4. The apparatus of claim 3, wherein the flexible spine portion further comprises at least one of:
a polymeric material overmolded onto the shapeable material, wherein the shapeable material comprises a polymer or a metal; or
the shapeable material, wherein the shapeable material comprises a shapeable polymeric material.

5. The apparatus of claim 1, wherein the retainer portion further comprises:
a cradle portion defined on the flexible spine portion, the cradle portion defining a cradle that is operable to receive the elongated article therethrough.

6. The apparatus of claim 1, wherein the retainer portion further comprises:
a cradle portion removably connected to the flexible spine portion, the cradle portion defining a cradle that is operable to receive the elongated article therethrough.

7. The apparatus of claim 1, wherein the first support connector further comprises:
a connector portion operable to extend into a lock channel defined in the first support surface, the connector portion further comprising:
a stem portion having a stem first end opposite a stem second end, the stem first end extending from the flexible spine portion, and the stem second end comprising a head portion that is spaced apart from the flexible spine portion, wherein a width of the head portion is greater than a width of the lock channel.

8. The apparatus of claim 1, wherein the retainer portion further comprises:
a stay portion operable to support the elongated article; and
a notched portion operable to receive a strap to attach the elongated article to the stay portion.

9. An apparatus comprising:
an attachment portion operable to attach to a first end of a conduit, the attachment portion including a clip portion operable to clip onto the first end of the conduit to attach the attachment portion to the first end of the conduit; and
a support connector operable to attach to a support surface, the support connector extending from the attachment portion.

10. The apparatus of claim 9,
wherein the support connector is operable to attach the support connector to the support surface, and
wherein the support connector defines an aperture that is operable to receive a mechanical fastener therethrough to attach the support connector to the support surface.

11. The apparatus of claim 9,
wherein the support connector includes a first side portion spaced apart from a second side portion,
wherein the support connector defines a strap passage that extends from the first side portion to the second side portion, and
wherein the strap passage is operable to receive a strap therethrough to attach the support connector to an elongated article that extends out of the conduit.

12. The apparatus of claim 11,
wherein the support connector includes a platform portion operable to support a portion of the elongated article that extends out of the conduit, and
wherein the strap passage is operable to receive the strap therethrough to attach the platform portion of the support connector to the elongated article that extends out of the conduit.

13. The apparatus of claim 12, wherein the platform portion is spaced apart from a base portion of the support connector to position the platform portion in a plane generally parallel to a plane of the conduit.

14. The apparatus of claim 9, wherein the support connector further comprises:
at least two guide arms operable to receive an elongated article therebetween.

15. An apparatus comprising:
an attachment portion operable to attach to a first end of a conduit, the attachment portion including a clamp portion operable to clamp onto the first end of the conduit to attach the attachment portion to the first end of the conduit; and
a support connector operable to attach to a support surface, the support connector extending from the attachment portion.

16. The apparatus of claim 15,
wherein the support connector includes a base portion spaced apart from a platform portion,
wherein the support connector defines an aperture that extends between the base portion and the platform portion, and
wherein the aperture is operable to receive a mechanical fastener therethrough to attach the support connector to the support surface.

17. The apparatus of claim 15,
wherein the support connector includes a first side portion spaced apart from a second side portion,
wherein the support connector defines a strap passage that extends from the first side portion to the second side portion, and
wherein the strap passage is operable to receive a strap therethrough to attach the support connector to the support surface.

18. The apparatus of claim 15,
wherein the support connector includes a first side portion spaced apart from a second side portion,
wherein the support connector defines a strap passage that extends from the first side portion to the second side portion, and
wherein the strap passage is operable to receive a strap therethrough to attach the support connector to an elongated article that extends out of the conduit.

19. The apparatus of claim 18,
wherein the support connector includes a platform portion operable to support a portion of the elongated article that extends out of the conduit, and
wherein the strap passage is operable to receive the strap therethrough to attach the platform portion of the support connector to the elongated article that extends out of the conduit.

20. The apparatus of claim 19, wherein the platform portion is spaced apart from a base portion of the support connector to position the platform portion in a plane generally parallel to a plane of the conduit.
